(19) United States
(12) Patent Application Publication
(10) Pub. No.: US 2007/0288362 A1
(43) Pub. Date: Dec. 13, 2007

(54) PROCESS, SYSTEM, SOFTWARE ARRANGEMENT AND STORAGE MEDIUM CAPABLE OF PROVIDING A MODEL TO DETERMINE A REPAYMENT VALUE ON A FINANCIAL VEHICLE WHICH IS A LOAN AND/OR AN INVESTMENT FOR AN ASSET

(75) Inventors: Frederick E. Pollock III, Henderson, NV (US); Andrew Caplin, New York, NY (US); Stephen Menzies, Sydney (AU)

Correspondence Address: DORSEY & WHITNEY LLP;INTELLECTUAL PROPERTY DEPARTMENT, 250 PARK AVENUE, NEW YORK, NY, 10177, US

(73) Assignee: New York University, New York, NY (US)

(21) Appl. No.: 11/835,920

(22) Filed: Aug. 8, 2007

Related U.S. Application Data
(62) Division of application No. 11/139,841, filed on May 26, 2005.

(51) Int. Cl. G06Q 40/00

(52) U.S. Cl. 705/38

(57) ABSTRACT

A process, system, software arrangement and storage medium are provided for facilitate an ability (or provide a model) to determine a repayment value on a loan and/or an investment for an asset (e.g., using a processing arrangement). In particular, first data associated with at least one of an actual time or an estimated time when the loan remains unpaid is obtained. In addition, second data associated with at least one of a sale price of the asset or a valuation of the asset is obtained at the time the loan/investment is satisfied. Further, the repayment value is determined based on, at least in part, the first data and the second data. In addition, a further process, system, software arrangement and storage medium are provided to establish the conditions for a loan of an asset (e.g., using the processing arrangement). The terms of the loan may be established based on data associated with unmodifiable terms of the loan provided by a borrower of the loan.

### FIELD OF THE INVENTION

The present invention relates to financial instruments, and specifically, to loan/debt instruments. In particular, the present invention is associated with process, system, software arrangement and storage medium which is capable of providing various financing options that may be based on the valuation of the underlying asset at the end of the financing term, and which can depend on additional information provided by the borrower of the underlying funds that are secured by the loan/debt instruments.

### BACKGROUND INFORMATION

It is known that mortgage markets may function in a sub-optimal manner. For example, whereas firms can use both debt and equity to finance investments, property holds remain restricted to pure debt finance, in the form of fixed or variable rate mortgages. Indeed, ordinary consumers are not provided with various options that may be available to large business entities. It is known that debt can be securitized, and the availability of additional mortgage product investment options may provided additional vehicle for investment options for various asset holders, enabling them to diversify away from the high risks involved in options such as equities, and to obtain the same expected returns at far lower returns. For those who believe that markets exist to allow gains from trade to be realized, it is clear that there is a strong case to be made that markets in housing equity will develop at some point in the future.

A publication—“Housing Partnerships” by Andrew Caplin, Sewin Chan, Charles Freeman, and Joseph Tracy, published by MIT Press in 1997, describes various advantages that markets in the housing equity market can provide to borrowers throughout their life cycle. For example, property holds that may have liquidity constraints, such markets enable them to have access to greater housing options. For borrowers who have some familiarity with the housing market, a extensive risk reduction benefits can be provided, as these borrower likely no longer have to have their portfolios dominated by a single home. Further, for more experienced borrowers, there is the potential to secure funds out of their home to assist with general expenditures, as well as to provide for certain unusual expenses as may arise as health risks increase in later life.

In the past, various scenarios have been proposed to address various changing needs of borrowers. For example, a shared appreciation mortgage (i.e., “SAM”) was developed to enable the borrowers to gain access to funds at a lower interest rate than the then-current high rates, by giving up a share of the appreciation in the home. However, the popularity of SAMs was reduced due to the decline in inflation. Other attempts to re-launch SAMs on a broader scale have failed. The present invention addresses the failures of the previous attempts by introducing the exemplary embodiments according to the present invention.

Recently, there has been an introduction of shared appreciation mortgages by the Bank of Scotland in the United Kingdom. In particular, it is believed that Bank of Scotland offered the borrowers up to 25% of the value of the home up front in exchange for up to 75% at point of termination, regardless of when such termination occurred. In particular, a three-to-one ratio between the amount borrowed and the share of appreciation owed applied even for loans for smaller amounts. For example, a 10% loan required payment of 30% of appreciation. This loan was open-ended, and had no fixed termination date.

One of the serious problems with the SAMs of the Bank of Scotland and other conventional shared equity mortgages is the inflexibility of their models which are used to determine the payback amounts. For example, the L % in 3 L % of appreciation out rule used by the SAMs of the Bank of Scotland involves a cost of capital to the borrower that depends on many factor, such as the time to mortgage termination and the rate of overall price inflation. Such variances in the cost of capital can generally make the model not only difficult for the consumers to understand, but also hard to justify in the marketplace. Such difficulties are illustrated in the following examples:

Example A1

A borrower takes out a $100,000 shared appreciation mortgage against a home that is valued at $500,000 using the SAM of the Bank of Scotland SAM terms. According to the terms of this particular SAM, this is a 20% up-front loan requiring the borrower to pay the lender 60% of the appreciation at the point of termination. Assuming that there is no inflation in the general price level, and the price of the underlying property increases by 10% to $550,000 in the first year. If the borrower terminates at that point, the loan repayment is $130,000, corresponding to a 30% p.a. real cost of capital to the borrower.

Example A2

Not only is the cost of capital with the loan of this form fairly high in the view of swift termination, but it is extensively influenced by the inflation. For example, in a variant of example A1, there is 10% inflation in the first year and the same 10% increase in the price of the underlying property. In such case, the value of the home at the end of the year is $605,000 instead of $500,000, and the amount due the lender at the point of termination is $163,000 instead of $130,000 (as in example A1). In this case, the real cost of capital to the borrower of the SAM is roughly 50%, and the borrower has been charged in real terms merely for the fact that there was an underlying increase in inflation. The reason for this addition increase is that the SAM treats appreciation and depreciation in an asymmetric fashion.

Example A3

A scenario substantially the same as that of Example A1 and the only change is the holding period of the loan. In particular, the price of the underlying property increases at a constant 10% p.a. over a 10 year holding period, with a terminal price of just below $1,300,000 at the end of year 10. If the borrower terminates at the 10-year point, the loan repayment would be $580,000. Computing the internal rate of return on this loan, the cost of capital to the borrower is revealed as 19.2% p.a., which while still high, is far lower than the 30% p.a. cost of capital in the case of termination only after one year of this identical price trajectory. As the holding period extends ever farther, the rate of return on this same loan with a 10% p.a. rate of the price appreciation of the underlying property is significantly decreased to a lower limit of 10% p.a. One of the problems with such varying rate of return is that it produces adverse selection, inducing borrowers with longer horizons to select the product, as well as a potentially moral hazard which may inducing those who use the product to retain the mortgages for as long as possible.

### OBJECTS AND SUMMARY OF THE INVENTION

One of the objects of the present invention is to provide various techniques, models and instruments that would overcome the deficiencies of the conventional techniques, models and instruments. These objects are addressed by providing, e.g., a pricing mechanism underlying the mortgage, and ability to provide investors with a reassurance concerning the timing of fund flows.

Thus, exemplary embodiments of the present invention are provided to address and overcome various deficiencies associated with the conventional mortgage and other lending products.

A first exemplary embodiment of the process, system and processing arrangement according to the present invention can be provided which can include a dynamic loan-to-value (“LTV”) pricing model (e.g., a “Rental Replacement Rate”). For example, conventional shared equity mortgages are not flexible with respect to the time it took the changing values of the financed home to take place, or the number of years that the mortgage can be maintained. The first exemplary embodiment overcomes such problems by basing the loan repayment obligation on, e.g., a changing or dynamic LTV model, which allows for a control of certain undesirable effects associated with poor incentive effects in conventional equity-shared loan instruments.

In accordance with a second exemplary embodiment of the process, system and processing arrangement according to the present invention, techniques and models for prepayment and repayment of the loan products that is associated with the equity of the financed home can be utilized, and preferably together with the LTV models. This is because, e.g., the mortgage products according to the present invention can be calibrated and priced in the LTV terms, as opposed to nominal dollar terms or dollar change in value terms as set forth in the conventional loan instruments.

A third exemplary embodiment of the process, system and processing arrangement according to the present invention can be provided which include utilize the information supplied by the proposed borrower to measure the termination of the loan, the availability of funds for the investor, etc. It is known that the unpredictability of debt holding periods may be ubiquitous, and can unnecessarily destroys asset value of the loan product (e.g., in relatively illiquid markets, in which long holding periods are typical). Previously, little or no attention has been afforded to the predictability of tenure of the loan product. The third exemplary embodiment addresses this deficiency by, e.g., providing various options to avail the predictability of the timing of cash-flows from the resultant pools of corresponding loan/debt instruments. In addition to the options associated with the term of the loan/debt, numerous other terms can be provided to enable a predictable and managed self-selection of the terms by the borrowers that can ultimately result in various debt-related asset pools that may include characteristics that are attractive to the investors. For example, the third exemplary embodiment of the present invention does not have to depend on the data associated with the LTV models, and addresses procedures for structuring various debt instruments to enhance predictability of tenure. Thus, shared equity mortgages can be one of many debt instruments for application by this exemplary embodiment of the present invention.

These and other exemplary embodiments of the present invention are described in further detail below. In particular, according to one exemplary embodiment of the present invention can be implemented using a process, system, software arrangement and storage medium which are provided for facilitate an ability (or provide a model) to determine a repayment value on a loan for an asset (e.g., real property), using a processing arrangement. In particular, first data associated with at least one of an actual time or an estimated time when the loan remains unpaid is obtained. In addition, second data associated with at least one of a sale price of the asset or a valuation of the asset is obtained. Further, the repayment value is determined based on, at least in part, the first data and the second data. In addition, a further process, system, software arrangement and storage medium are provided to establish the conditions for a loan of an asset (e.g., using the processing arrangement). The terms of the loan may be established based on data associated with unmodifiable terms of the loan provided by a borrower of the loan.

In another exemplary embodiment of the present invention, the determination of the repayment value excludes a use of data associated with the value of the asset at the time the loan is secured. Further, the determination of the repayment value may be capable of providing the repayment value to be lower than the value of the asset at the time the loan is secured. In addition, the determination of the repayment value may be based on at least one of a maximum repayment amount or a maximum repayment percentage at a termination of the loan.

In still another exemplary embodiment of the present invention, if the loan is being satisfied after a predetermined termination date of the loan, a further repayment value of the loan can be established based on the repayment value and without regard to either of the maximum repayment amount or the maximum repayment percentage. The repayment value may also be determined as a function of a rate that is associated with a use of proceeds of the loan. The rate may be a rental replacement rate or use of funds rate. As an alternative or in addition, the repayment value can be determined as a function of particular proceeds of the loan which have been previously authorized and not utilized by a borrower.

In yet another exemplary embodiment of the present invention, the repayment value may be modified based on at least one of additional charges or additional fees associated with a maintenance of the asset. Further, predetermined time periods for repaying the loan may be established, and the repayment value may be adjusted if the loan is satisfied outside the predetermined time periods, e.g., based on a value that is associated with an unpredictability of a current market. An insurance component for the loan may be established such that the repayment value may be determined as a function of the insurance component. The insurance component may be associated with a market value of the asset, and the determined repayment value can be reduced based on the insurance component if the value of the asset at the time of repayment of the loan is lower than the value of the asset at the time the loan was initiated.

In addition, the rental replacement value may be a predetermined value which is based on characteristics of the asset and/or current market conditions. The repayment value of the loan may be increased if the loan is satisfied prior to a predetermined termination period of the loan. Further, the valuation of the asset can be automatically produced during a predetermined termination period of the loan.

The asset may be real property, and the valuation of the asset can be automatically produced and the repayment value automatically generated when a borrower of the loan for the real property is required to withdraw from the real property. Further, the repayment value may be determined based on particular information regarding a repayment of the loan provided by a borrower of the loan., and can include an estimated time period for satisfying the loan. The repayment value may be increased if the loan is outstanding after the estimated time period, and/or reduced if the loan is outstanding within the estimated time period. The second data may be associated with a greater of the sale price of the asset and the valuation of the asset.

These and other objects, features and advantages of the present invention will become apparent upon reading the following detailed description of embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is an exemplary block diagram of a system that enables an implementation of a lending application and process in according to with an exemplary embodiment of a model of the present invention;

FIG. 2 is a flow diagram of an exemplary embodiment of the equity-shared loan origination process in accordance with the present invention;

FIG. 3 is an exemplary embodiment of a process according to the present invention for enabling the borrower to self-select a loan that is most desirable thereto according to the types of available equity-shared loans;

FIG. 4 is an exemplary embodiment of a process according to the present invention for determining the amount due for the equity-shared loans

FIG. 5 is an exemplary loan-to-value (“LTV”) graph at future periods of the equity-shared loan/mortgage using the methods, processes, software arrangements, techniques and models in accordance with the present invention; and

FIG. 6 is a flow diagram of an exemplary embodiment of a process according to the present invention to determine the payoff in the terminal LTV; and

FIG. 7 is a flow diagram an exemplary embodiment of a process according to the present invention to provide a valuation assessed to any given property at a point of a prepayment.

While the present invention will now be described in detail with reference to the figures, it is done so in connection with the illustrative embodiments.

### DETAILED DESCRIPTION

I. Dynamic LTV Pricing Model

One of the important features of pure shared-equity mortgages is that such mortgages do not involve a payment of regular mortgage interest during the term of the loan. Using these mortgage models, instead of paying for the interest and principle during the life of the loan, the borrower pays the lender the combined principle and interest amount only at the termination of the mortgage. At the point of termination, the total payment to the lender is primarily dependent on the value of the property. The conventional shared-equity mortgage products provide a formula connecting the extent of the debt to the terminal value of the property.

For example, using the shared appreciation mortgages (SAMs), the lender obtains from the borrower a note to repay a certain fixed share of the appreciation of the underlying property. In the case the SAMs made available by the Bank of Scotland, a borrower taking a certain percentage (L %) of the value of the property up front owed the lender 3 L % at point of termination, regardless when such termination has occurred. This and other conventional models are deficient in that they effectively decelerate market development. One of the benefits afforded by the exemplary embodiments of the present invention is the pricing model that is based on a dynamic loan-to-value (“LTV”) formula that is believed to accelerate a future large scale development of a market in SAMs.

A. Exemplary Uses of Dynamic Loan-to-Value Pricing Model

In order for the market to develop, it is preferable to provide a pricing mechanism which is less effected by the variances of the national economy (e.g., in the form of inflation) and borrower decisions (e.g., in the form of the date of mortgage termination). In addition, the pricing should be perceived as being fair, in the sense that the cost of capital should reflect the period for which the money was in fact borrowed, while allowing the sharing of the financial risks and rewards of property ownership between lender and borrower. Further, the pricing should be relatively simple to understand for all market participants. One of the exemplary embodiments of the present invention addresses such needs by providing a system, process, storage medium and software arrangement which bases the debt of the borrower at any point in time on a model/technique which allows for a dynamic accrual of the lender's interest as measured by a share in the price of the underlying property. Provided below are illustration of the operation and outputs of the exemplary model according to the present invention which overcomes the deficiencies and problems associated with the conventional shared-equity mortgage models whose rate of return is profoundly effected by inflation and turnover times. The exemplary dynamic loan-to-value (“LTV”) model according to the present invention can be based on a particular pricing technique, e.g., the rental replacement rate, which can be used to define the current rate of growth over time in the outstanding LTV on the loan.

B. Exemplary Rental Replacement Rate

To provide the durability and flexibility to the market, the exemplary embodiments of the present invention provide an exemplary pricing concept, e.g., the rental replacement rate, R (or usage rate) which can be important to determine the cost of the funds to the borrower, and the return on capital to the lender. The exemplary rental replacement rate can be used in a model in accordance with the present invention to charge, e.g., a periodic rent (or usage of funds) that can allow interest to be charged in terms of housing or property units. This rate R can be a “pure housing/property” version of the interest rate, and also can be flexible and adaptable to changes in market conditions, consumer interest, and investor interest.

Accordingly, this rate may be an additional price, since the change over time and according to circumstances acts similarly to the rate of interest on standard mortgages. On the other hand, such rate is different from conventional rates on interest, since such mortgage can be utilized in terms that are other than monetary terms, i.e., in terms of housing value units. Various examples illustrating the use of this exemplary model according to the present invention can be used is described in greater detail below. For example, with this exemplary model, it is possible to use a price that applies at each moment that makes it clear to the borrower that he/she is being charged for the use of funds, e.g., in terms of housing units instead of in terms of money.

C. Overview of Equity-Shared Lending Process

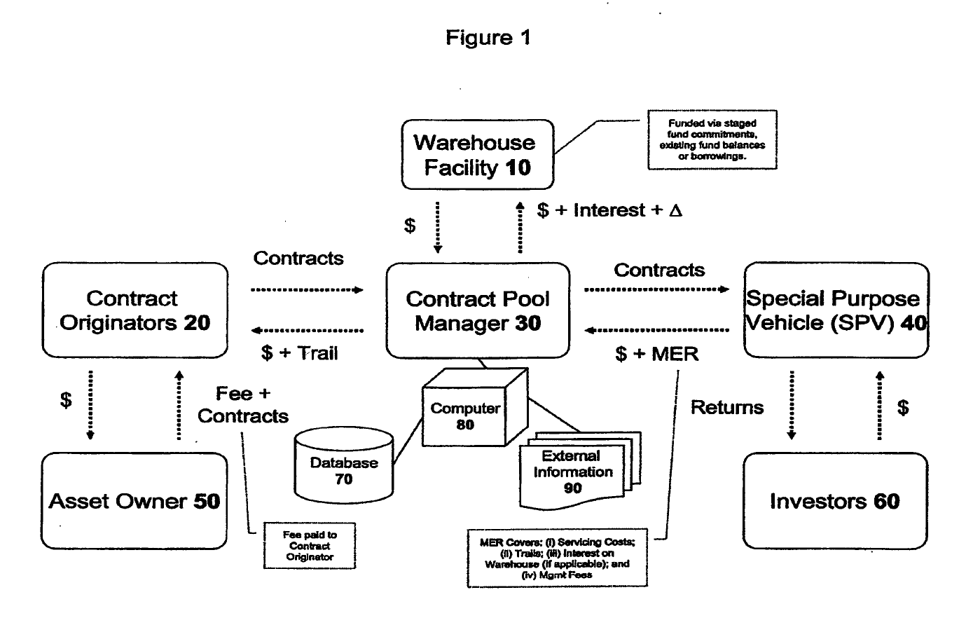

An exemplary embodiment of a system for implementing the present invention is shown in FIG. 1. For example, a central coordinator of the overall equity-shared lending process can be referred to as a contract pool manager 30. The contract pool manager 30 enters into various mortgage contract distribution relationships with contract originators 20, which then enter into contracts with asset owners 50 so as to lend funds or securities in exchange for an equity interest in the underlying asset. The contract pool manager 30 arranges for funds to be provided to the contract originators 20 in order to fund the contracts. These funds are drawn from a warehouse facility 10, which could be funded in several ways. The contract pool manager 30 takes the contract, and pools them into a structured vehicle (i.e., a “special purpose vehicle” 40). Interests in the structured vehicle can then be sold to investors 60. Throughout this exemplary process, the contract pool manager 30 can utilizes a processing arrangement which may include a determiner 80, a database 70, and an apparatus which receives and/or stores external information 90 thereon (i.e., storage device which can store thereon title information for the asset).

D. Equity-Shared Loan Origination Process

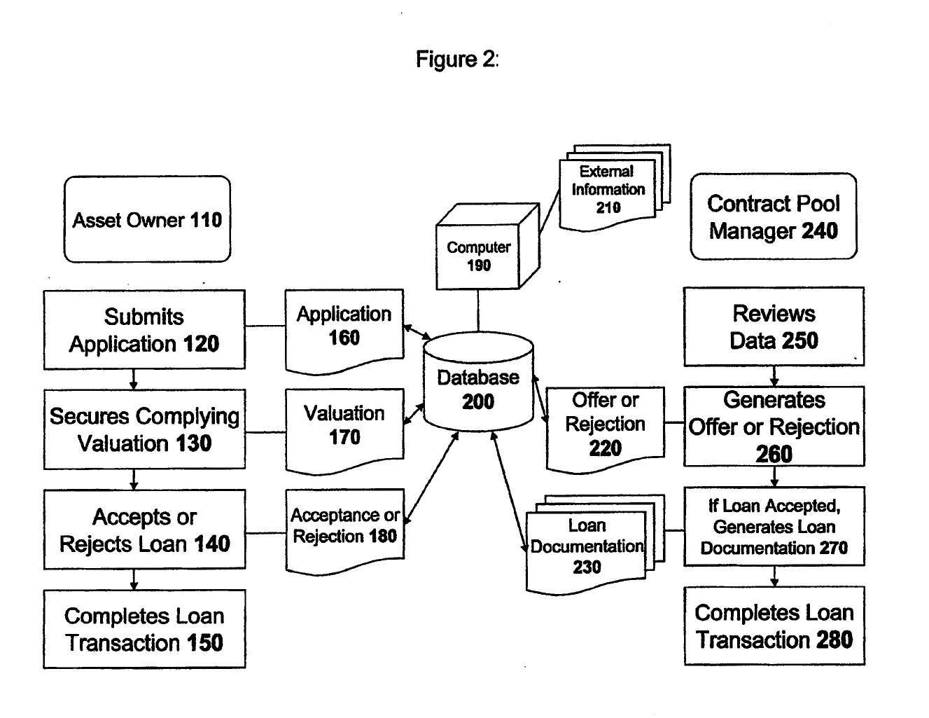

FIG. 2 shows a flow diagram of an exemplary embodiment of the equity-shared loan origination process in accordance with the present invention. For example, an application 160 is submitted by an asset owner 110 (in step 120). If the asset owner 110 proceeds to the next step in the process, the asset owner 110 can secure a complying valuation 130 of such asset. The valuation procedure (in step 170) and the application can be placed in a database 200. Using a processing arrangement 190 (e.g., a determiner) and which can access external information in step 210, the contract pool manager 240 can review data in step 250, and generates an offer or a reject in step 260. This offer or rejection decision is recorded in step 220, and provided to the asset owner 110. If there was an offer, the asset owner 110 accepts or rejects the offer 140 of a loan. The acceptance or rejection by the asset owner in step 180 is recorded and provided to the contract pool manager (or another acting as agent for such throughout this process). If the offer of a loan was accepted, loan documentation is generated in step 270. This loan documentation is recorded in step 230, and reviewed by all parties. If the transaction is finalized, then the asset owner completes the transaction in step 150, and the contract pool manager 240 completes the transaction in step 280.

E. Equity-Shared Loan Amount Due Determination Process

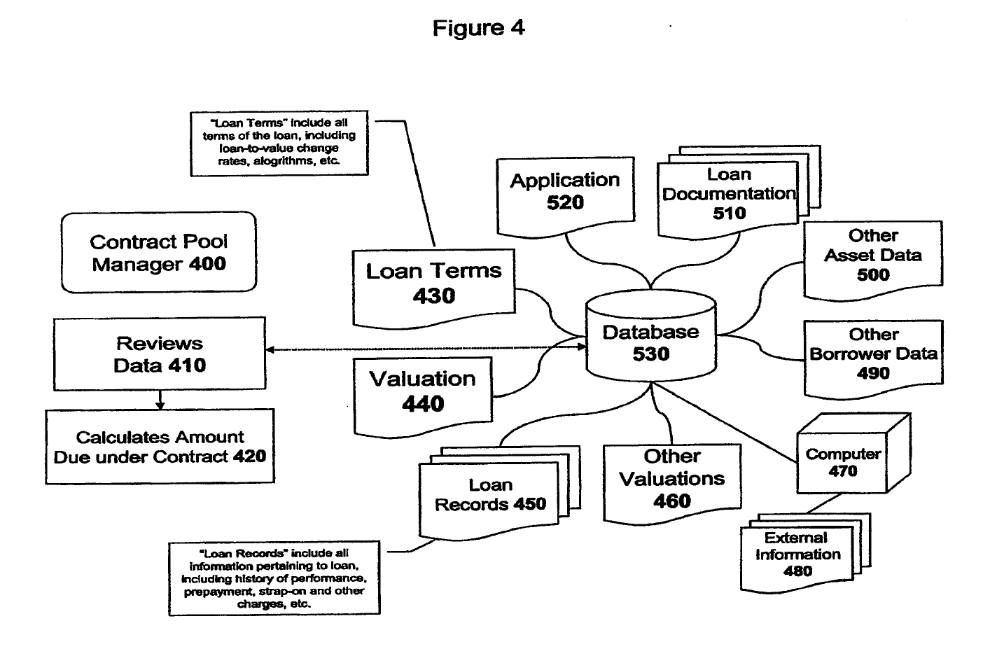

FIG. 4 shows an exemplary embodiment of a process according to the present invention for determining the amount due for the equity-shared loans. Throughout the term of the mortgage and/or at termination, according to one exemplary embodiment of the present invention, there may be times when the amount due should be determined as set forth in step 420. The contract pool manager 400 can review data in step 410 using a processing arrangement (e.g., a determiner) 470, and access both the external information 480 and a database 530 on per-need basis or automatically to determine the amount due on the loan. The database 530 can store various records, such as, e.g., the loan terms 430, a valuation model and results 440, loan records 450, other valuation information or valuations for other loan products or for other borrowers 460, other borrower data 490, other asset data 500, loan documentation 510, loan application 520, etc. This exemplary process can be performed by one or more processing arrangements (arranged together or separately) which are provided in communication with storage arrangements (e.g., hard drives, RAIDs, RAMs, ROMs, CD-ROM drives, memory sticks, floppy disks, tapes, etc.), and/or connected to a communications network (e.g., Internet, intranet, cable modem, telephone, etc.). Indeed the data received and generated using the processing arrangement(s) can be transmitted internally and/or externally to other systems and arrangements, as should be understood by those having ordinary skill in the art.

F. Exemplary Embodiment—Dynamic LTV Model

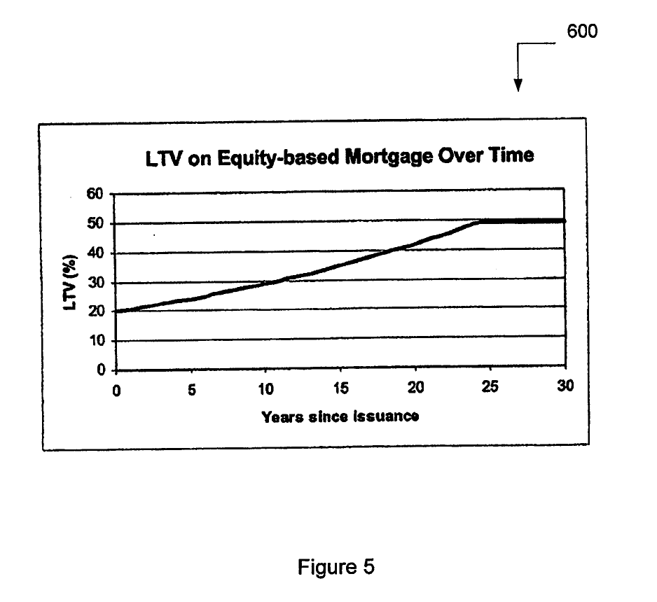

The concepts of the rental replacement rate and the Dynamic LTV pricing process are effectuated by various Dynamic LTV models. For example, FIG. 5 shows an exemplary LTV at future periods of the equity-shared mortgage using the methods, processes, software arrangements, techniques and models in accordance with the present invention.

For example, in the time that the loan is outstanding, the LTV on the loan grows at the contractually specified rate (e.g., the rental replacement rate) according to the exemplary embodiment of the Dynamic LTV model. The above example can be further described using the following model. For example, if a mortgage is initiated at time t=0 in dollar amount M(0) on a property that has initial value assessed either by the mortgage holder or an outside source as V(0). The initial LTV on the loan utilizing the exemplary model of the present invention, L(0), can be defined in the obvious percentage terms as the ratio of the loan size to the property value, M(0)/V(0). At any later time T>0 at which the mortgage is terminated, the borrower owes the lender an increasing share over time in the value of the property. The Dynamic LTV Model according to the present invention can specify the terminal LTV L(T) on the mortgage at any time at which it may be terminated. Thus, the pricing of the Dynamic LTV model is preferably based on the accrual at a contractually specified rental replacement rate.

As one example of the use of the dynamic LTV model in accordance with the present invention, as shown in FIG. 5, the equity-shared mortgage is issued initially at a 20% LTV, and having a cap at an LTV of 49%. As shown in a graph 600 of FIG. 5, with a rental replacement rate (e.g., a rate of the dynamic LTV of 3.75% per year, it takes 6 years for the LTV to grow to 25%, about 11 years to reach 30%, approximately 18.5 years to reach 40%, and about 24 years before reaching the maximum 49%.

As an example, consider a property with an initial value of $500,000 and a terminal value of $1,000,000. If 20% of the initial value (i.e., $100,000) is borrowed based on such terms, the initial LTV (Lᵢ) would equal to 20. If the mortgage terminated after ten (1) years, the final LTV based on such terms would be 29.1%. Therefore, the initial loan of $100,000 would result in a final payout by the borrower to the lender in the amount of $291,000 at the end of this 10-year period (i.e., 29.1% of the terminal value of the property of $1,000,000).

G. Further Examples

For example, one exemplary embodiment of the Dynamic LTV model can be considered, in which the share of the property value due to the lender grows over time at a constant exponential rate (e.g., 4% per year over a fixed twenty year loan life). In this case, the LTV at any time T prior to the termination in year 20 can be defined by a formula L(T)=20e^{0.04}T. Rather than being measured in discrete units, such as years or quarters, time in the exemplary model according to the present invention can be taken into consideration based on years which are fractional, and possibly rounded to two or more decimal places.

Example I: Consider a borrower taking out a $100,000 an equity-shared mortgage which utilizes the exemplary embodiment of a model in accordance with the present invention against a $500,000 home in which the LTV at termination is defined by the formula L(T)=20e^{0.04}T. Assume that there is no inflation in the general price level, but that the property increases in price by 10% to $550,000 in the first year. If the borrower terminates at this point, the terminal LTV on the loan is L(1)=20e^{0.04}=20.8%. Therefore, the loan repayment is the value of the home is multiplied by 0.0[L(1)]=0.208, yielding a repayment amount of $114,400. This repayment corresponds to a 14.4% p.a. real cost of capital to the borrower.

Example II: A variant of the above Example I can be illustrated in which there is 10% inflation in the first year as well as the same 10% increase in the value of the property. In this case, the value of the property at the end of the year is $605,000, instead of $500,000. Therefore, the amount due to the lender at point of termination of the loan is $125,800, instead of $114,400. It should be noted that the 14.4% p.a. real cost of capital to the borrower is unchanged by the presence of inflation, since the payment is proportional to the value of the home, and unlike the conventional SAMs, the model in accordance with the present invention does not treat appreciation and depreciation in an asymmetric manner.

Example III: Consider a substantially identical scenario to that provided above in the Background Information section, in which the property price increases at a constant rate of 10% p.a. over a 10 year holding period, with a terminal price being just below $1,300,000 at the end of year 10. If the borrower terminates at that point, the terminal LTV on the loan utilizing the exemplary model of the present invention is provided by the formula by L(10)=20e^{0.4}=29.8%. This means that the loan repayment is close to $390,000. Computing the internal rate of return on this loan, the cost of capital to the borrower would be 14.4% p.a., which has not been impacted in any manner by the holding period. The reason for such positive result is that with constant property price growth and the constant accrual according to the dynamic LTV formula, there are likely no factors provided in the exemplary model of the present invention that may account for the changes in the rate of return on the loan.

Example IV: Consider exactly the same lending scenario, and assume that the loan terminates after five years at a point at which the property value has not changed from its initial $500,000. In such case, mechanically applying the Dynamic LTV in accordance with an exemplary embodiment of the present invention provides the terminal LTV at the end of the five years as, L(5)=20e^{0.2}≈24.4. Thus, the amount due to the lender is 24.4% of $500,000, which is approximately $122,000 (i.e., $22,000 more than was originally borrowed).

Example V: Again, the same scenario is provided, but the loan terminates after five years at a point at which the property value has fallen by 20%, i.e., to $400,000. In such case, the amount due to the lender is 24.4% of $500,000, which is approximately $97,600. The fact that the amount due at termination is below that at initiation illustrates one of the novel aspects of the exemplary embodiment of the model according to the present invention. Indeed, according to an exemplary scenario that utilizes the present invention, the interest rate does not always have to be positive, since is factored off the price of housing, which cannot be guaranteed to increase.

H. Incorporating Upper Bound

While the exemplary embodiment of the model in accordance with the present invention can apply without changing simple settings, there are certain cases in which the growth over time in the share due to the lender may be considered as excessive unless a bound or limit is placed on its growth. It may be beneficial for the homeowner to maintain a significant interest in the final sale price of the home. This additional optional feature according to the present invention would allow the monitoring and compliance costs to be reduced, since the incentives of the lender and borrower are so strongly aligned to increase the value of the property. For this exemplary reason, the exemplary dynamic LTV model according to the present invention may also include the use of a limit on the proportion due to the lender. In order to ensure that this gap is not breached in normal circumstances, an upper bound or limit may be placed on the initial LTV that can depend on the term of the loan and the usage of funds value or the rental replacement rate to ensure that the limit does not lead to a major diminution in the returns to the lender.

For example, in one exemplary embodiment of the present invention, the upper bound can be specified as 49% of the loan amount. The exemplary Dynamic LTV model in such case provides that there is constant rate of growth in the LTV on the loan that is capped as soon as it would otherwise overstep the upper limit of 49%. Complementary bounds on the initial LTVs can be set to confirm that the 49% upper bound is overstepped only toward the very end of the loan's termination date. A model which uses a formula L^{U}(0)(H,M,R^{V},u) can be used to specify the upper bound or limit on the initial LTV on the exemplary embodiment of the loan in accordance with the present invention with a preferred habitat H, the maximum term M, that depends also on the usage of funds or rental replacement rate vector R^{V}, and an unpredictability compensation fee u.

I. Use of Usage of Funds or Rental Replacement Rate to Influence Term

Some of the conventional shared equity mortgages are generally open-ended. The exemplary dynamic LTV model in accordance with the present invention allows for the development of a more variable and flexible set of termination options that may be valuable in a market development efforts. This is likely because, incentives may be provided to the borrowers to make decisions that assist investors in predicting product terms, as shall be described in further details herein.

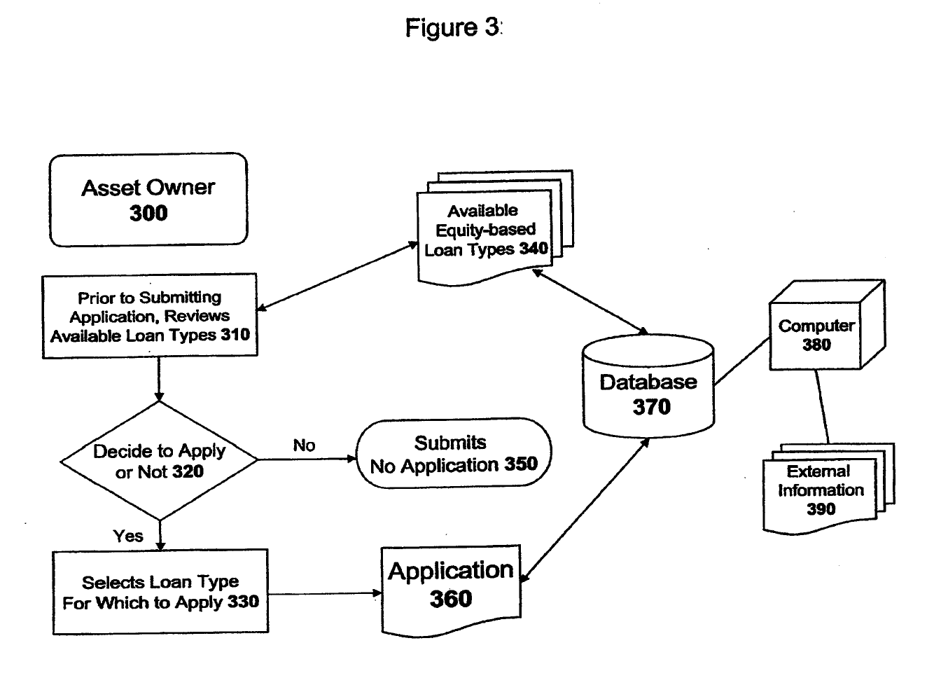

For example, FIG. 3 shows an exemplary embodiment of a process according to the present invention for enabling the borrower to self-select a loan that is most desirable thereto according to the types of available equity-shared loans. As shown, prior to submitting a loan application, the asset (e.g., property) owner 300, reviews the available loan types 340 (e.g., in step 310). The available loan types 340 and their terms are recorded in a database 370. Using a determiner 380, the loan type 340 and associated terms are generated, e.g., using external information 390, and provided to the asset owner 300. The asset owner 300 can determine whether to apply for the presented loans (in step 320) based on the presented and/or available loan types and their terms. The asset owner 300 would have the application to decline to submit anything further (in step 350), or selected a particular type of a loan in step 330, based on the information obtained or provided in an application therefor 360. This information can be recorded in the database 370, and used by the determiner 380 (e.g., in conjunction with external information as needed), throughout the remaining processes and in the future.

As an example of the use of the rental replacement rate as a pricing instrument to influence term and predictability, various exemplary embodiments of the present invention can utilize a concept of a preferred habitat, H, which may be shorter than the maximum term of the loan, M. For each such product there may be a different rental replacement rate that varies according to both habitat H and term M. The borrower who takes out a loan with the preferred habitat H that is shorter than the maximum term M may have an option to roll it over until the end of term. However, the exercise of this option can effectuate an “unpredictability compensation fee” u>0 (that may be established in the context of the exemplary Dynamic LTV model) on the amount that was rolled over.

Example I. A loan in accordance with an exemplary embodiment of the model of the present invention may have a 5 year preferred habitat term that includes an automatic option to extend to a 10 year maximum term upon payment of the unpredictability compensation fee. In this case, for example, for all times before the end of the five year preferred habitat, the termination LTV likely grows exponentially at the rate R(5,10), which is the use of funds rate or the rental replacement rate for the specific loan, with preferred habitat of 5 years and maximum term of 10 years. However, when the five years pass, there would likely be an immediate and/or automatic penalty charged to the borrower which can be defined by the unpredictability compensation fee. Continuing for this point until the end of the maximum term of 10 years for the loan, the LTV grows exponentially at the rate R(10,10), which is the rental replacement rate for the product with preferred habitat of 10 years and maximum term of 10 years.

In this context, taking an example in which $100,000 loan is provided that utilizes an exemplary model in accordance with the present invention on a property that is originally valued at $500,000. For example, this loan may have the following model characteristics (H,M)=(5,10). In addition that R(5,10)=0.04, R(10,10)=0.05, and u=0.05. If the mortgage terminates after precisely 5 years, the model uses a formal which is substantially similar to the formal described herein above, i.e., by using the numbers therein of L(5)=20e^{0.2}≈24.4. In an alternative scenario in which the loan on the property is terminated after 10 years when the property value is $1,125,000.

In this exemplary case, the appropriate exemplary model in accordance with the present invention can involve three charges, and the exemplary model can be implemented as follows to provide the repayment result for the loan, i.e., L(10)=20. e^{0.2+0.05+0.25}=20.e^{0.5}≈33. The first term with respect to the exponent (i.e., 0.2) corresponds to 5 years of the usage of funds or rental replacement rate charged at R(5,10). The second term provided at the exponent (i.e., 0.05) is the unpredictability compensation fee. The final term with respect to the exponent (i.e., 0.25) corresponds to 5 years of the usage of funds or rental replacement rate charged at R (10,10). Therefor, the overall repayment on the loan can be determined to be approximately 33% of $1,125,000, which is approximately $374,000.

J. Repayment Beyond Term

It may be beneficial to provide incentives to the borrowers to repay the loans promptly at point of the termination of the respective loans. The usage of funds rate or the rental replacement rate can allow shared-equity loan provider to provide incentives for a rapid termination using a LTV penalty in accordance with the exemplary embodiment of the present invention. For example, the loans can become due at the moment (or time period) that the maximum term M is reached. However, there may be cases in which a short settlement period is preferred in order for the funds to be repaid. For example, this may be the case when the property passes to estate at the time that its maximum term is reached, and there is a preference for a period of 12 months to arrive at the settlement of the loan. Such extensions can trigger an unpredictability compensation charge, in addition to continuing to draw various charges according to a pre-defined usage of funds or rental replacement rate. In addition, in such cases in which there is an extension beyond the term of the loan, the usage of funds rate or the rental replacement rate can continue at the rate at which it was last charged until the point of the termination of the loan.

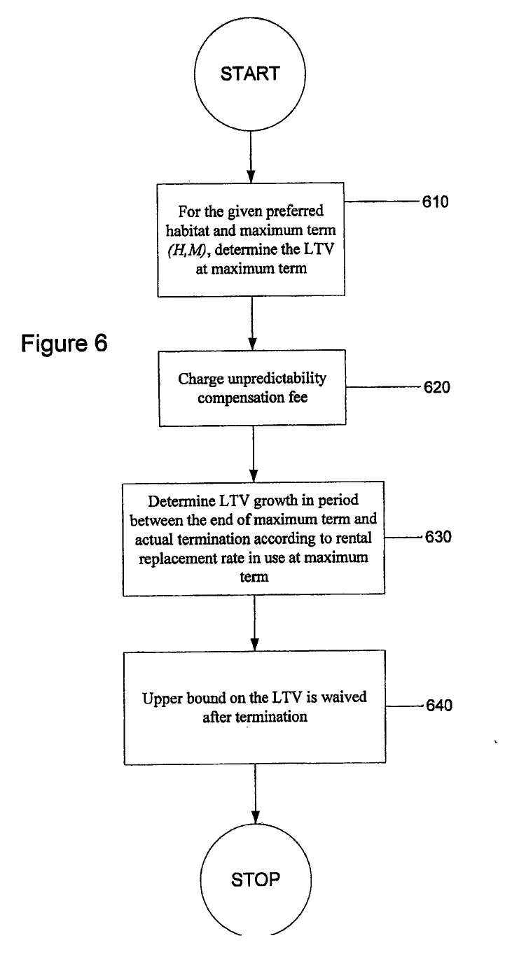

As an example, provided below is a description of how the exemplary embodiment of the model in accordance with the present invention operates in conjunction with the terminal LTV at any time T>M. For example, to determine the payoff in the terminal LTV in this case can take several steps, as shown in an exemplary flow diagram of FIG. 6 illustrating this exemplary process according to the present invention. First, in step 610, for the given preferred habitat and a maximum term (H,M), the loan utilizing the exemplary model of the present invention determines the LTV at the maximum term as set forth herein above. At that point, the unpredictability compensation fee is charged (step 620), and LTV growth in the period between the end of maximum term and actual termination is determined according to the rental replacement rate in use at maximum term (step 630). In addition, the 49% upper bound on the LTV is waived after termination (step 640).

To illustrate these exemplary principles of the present invention, consider again the $100,000 loan which utilizes the exemplary model according to the present invention on a $500,000 property, with (H,M)=(5,10), and in addition that R(5,10)=0.04, that R(10,10)=0.05 and that u=0.05. For example, the borrower extends 2 year over the term, and terminates the loan after 12 years, at which point the property still has value of $1,250,000. In this case, it is possible to add the unpredictability compensation fee of 0.05, and two years additional usage of funds/rental replacement rate at R(10,10)=0.05 to arrive at L(12)=20e^{0.5+0.05+0.1}≈38.3. Hence, the repayment on the loan would be approximately $479,000.

K. Multi-Draw

The flexibility provided by the usage of funds/rental replacement rate can enable the lenders that provide shared equity loan products to offer the borrowers various beneficial options. For example, it is possible to allow the borrowers who do not have need immediately for all of the funds that they have the right to borrow to retain an unused balance, on which they would not be charged the rental replacement rate. As an example, consider a borrower who takes out a share-equity loan in accordance with the present invention larger than is needed for the first drawing of the capital. In this case, the exemplary model described above for the final LTV can be used to characterize the prepayment due on the actual drawn part of the mortgage. It is them possible to add back in the un-drawn portion of the loan to obtain the overall terminal LTV. Further, at some time t>0, an additional withdrawal is obtained (e.g., borrowed). The incremental LTV can be determined using the initial property value. It is also possible to iterate the above exemplary procedure when there are multiple uses of the multi-draw capability. This feature could be used in products which provider for a regular payment or series of payments (for example, monthly) to the homeowner or the homeowner's nominee to create a recurrent payment schedule, which in its operation, would resemble an annuity, but draw upon the equity value of the home (and therefore is distinctive from reverse mortgage products).

Consider again the example above with a $100,000 loan on a $500,000 property, and with R=0.04. Suppose, in the present example, that only $50,000 of the $100,000 loan is drawn on the mortgage on initiation, while the remainder is left undrawn throughout the life of the loan (which terminates in year 5) at which time the property is worth $750,000. In this case, the LTV on the 10% portion of the loan withdrawn terminates at 10e^{0.2}≈12.2. Adding back to the undrawn portion of the loan produces the overall terminal LTV of 22.2.

L. Strap-On Charges

As one example of the model in accordance with the present invention, there are various strap-on charges that may have to be placed on shared equity mortgages during the life of the loan (e.g. paying for the property insurance due to a failure of the borrower to pay for such insurance). It is possible to impose strap-on charges which would likely have various implications for the payoff model. In one exemplary embodiment of the present invention, the final payoff on the value-based portion of the loan can be globally capped at 49% of the value of the property. The strap-on charges, however, may lie completely outside this upper bound/limit, and can result in the loan terms (including the upper bound/limit) being breached. Suppose, e.g., that the strap-on charge in dollar amount S(t) is made at time t. This and all subsequent such payments can be treated as adding a new component to the share of the property according to the valuation that is assigned to the property at that time using the procedures used to determine the value in the cases of scheduled prepayments (e.g., but without the adjustment based on the need to recover the initial value in the case of the prepayments). For the first and any subsequent strap-on, the LTV of the strap-on charge itself at the point of making the charge can be easily determined. From that point forward, the LTV on the portion of the loan can grow at precisely the contractually specified rate on the loan itself, and can incur also the unpredictability compensation charge of the remainder of the debt. However, the strap-on additional charges to the LTV are likely provided completely entirely outside the 49% upper bound/limit aspect of the model, and are generally not included in determining whether or not the limit has been reached.

Further, e.g., suppose that a single additional charge of $2,000 was placed on the property which was most recently appraised as being worth $200,000. In this exemplary case, the additional charge may be treated as if an additional loan of 1% of the property value was made at the corresponding date, and the final share on this addition grows continuously at the applicable usage of funds/rental replacement rate for the ensuing period prior to the termination of the loan. The growth in the strap-on charge may continue indefinitely, even if the maximum (upper bound/limit) of 49% is reached and surpassed. Indeed, the 49% upper bound rule may likely apply only to the initial loan.

The impact of strap-on charges on the LTV can also be used to monitor the LTV over and above the standard 49% upper bound/limit. The role of the 49% upper bound/limit on the lender's share of the property price is to ensure that the incentives of the lenders and borrowers align. If there are excessive strap-on charges, it may not only threaten this alignment of interest, but also can suggest a pattern of neglect of the contract terms. Thus, the termination events may be defined based on the share of the strap-on charges owned to the lender, and the borrowed amount of the loan rising above the upper bound/limit. In one example, the total limit on the repayment of the loan can be 59% of the property value, e.g., inclusive of all strap-on charges.

The exemplary process of property valuation at a point when the strap-on charge is made is described below.

M. Prepayments—Scheduled and Otherwise

It is also possible to divide prepayments of the outstanding loan into scheduled and over-schedule quantities in accordance with another exemplary embodiment of the present invention, which is used with the exemplary model according to the present invention. To describe this exemplary embodiment, an example is provided below in which 15% of the outstanding debt (as determine) is used to ascertained the amount that needs to be repaid in each period according to the schedule.

1. Computing LTV Impact on Scheduled Prepayments

According to an exemplary embodiment of the present invention, one of the reasons to provide a scheduled prepayment is to instantaneously lower the LTV on the loan by a certain adjustment factor that can depend on the amount prepaid, and the price that the lender charges to pay off each LTV unit. Once this once-off adjustment is made at the point of the prepayment, the LTV on the loan can resume its growth according to the standard rental replacement rate schedule. Consider a prepayment at time t prior to the termination (as with the termination time, t is measured continuously in years rounded, starting with t=0 at the point at which the mortgage is initiated). In order to calculate the total debt outstanding at this time for the loan, the first computation is the LTV on the loan at this point.

This LTV can be determine using the Dynamic LTV model in accordance with the present invention as if the mortgage was being terminated at that time. However, in one exemplary variant of the present invention, the model may not accept value-based losses at point of the prepayment of the loan. Therefore, the total debt D(t) as determined at a point of the prepayment as the LTV at that time, L(t), is multiplied by the maximum of the property valuation at date t, and the initial value of the property. The impact on the LTV (at time t) of the prepayment at time t of dollar amount PP(t) is to produce a downward adjustment in the LTV at time t of δ(t), which can be defined as the ratio of the prepayment to the total debt δ(t)=PP(t)/D(t). There is generally no difference in the cases in which there is more than one prepayment. The only difference may be that it is possible to repeat the above procedure for determining the ratio of prepayment to debt for each prepayment that has been made.

As an example, consider the simplest case of all in terms of the parameters of the mortgage that used the exemplary model according to the present invention. In particular, for a $100,000 loan may be taken for a $500,000 property, and thus L (0)=20. In this example, there may be a fixed usage of funds/rental replacement rate R=0.04 on such loan throughout the term thereof, which extends for more than 10 years. Suppose that a prepayment for the loan is made in amount of PP(5)=$18,300 in year 5 of the mortgage at a point at which the value of the property V(5)=$750,000. In this case, the total debt at this point is determined as D(t)≈$183,000. In such case, the downward adjustment in the LTV of δ(5) can be determined as δ(5)≈0.1. Thus, at the time of the prepayment in year 5, the LTV on the loan is reduced from L(5) as provided by the previously described exemplary model to its post-prepayment level L₁(5),
L₁(5)=[1−δ(5)]L(5)=0.9 L(5).

Consider the same case as described above, such that the property has an initial value V(0)=$500,000, with L (0)=20, and with R=0.04. Suppose again that the prepayment is made in amount of PP(5)=$18,300 in year 5 of the loan. However, further assume that the value of the property has fallen to V(5)=$250,000. Because there are no losses allowed at the point of the prepayment, the actual total debt for purposes of prepayment is determined from the property value at its initial level, rather than at its reduced level as in year 5. Therefor, the total debt at this point is determined to be 24.4% of $500,000, and thus, D(t)≈$122,000. In this case, the downward adjustment in the LTV of δ(5) can be determined as δ(5)≈0.15. For example, this can be the maximum level for the scheduled prepayment. Therefore, at the time of the prepayment in period 5, the LTV on the loan is reduced from L(5) as given by the standard loan utilizing the exemplary model of the present invention to its post-prepayment level L₁(S),
L₁(5)=[1−δ(5)]L(5)=0.85 L(5).

2. Adjusting Payoff Formula for Scheduled Prepayments

According to one exemplary embodiment of the present invention, the LTV can be adjust by the scheduled prepayment by performing a post-prepayment imputation of the initial LTV as [1−δ(t)] times the actual initial LTV. To determine the final LTV, it is possible to utilize the above-described Dynamic LTV model along with the post-prepayment imputation of the initial LTV, instead of the actual initial LTV.

Consider the loan with L(0)=20 and R=0.04, with the prepayment adjustment of δ(5)=0.1 in year 5. In this case, the post-prepayment imputation of the initial LTV is therefore 0.9 (20)=18. Further, assume that the loan terminates in year 10 at which 0.4 point the property is worth $1,125,000. In this case, the terminal LTV is L(10)=18e^{0.4}≈26.8. Given that the terminal value of the property is $1,125,000, the amount due to the lender is approximately $301,000.

Consider the same loan with L(0)=20 and R=0.04, but with the prepayment adjustment of δ(5)=0.15 in year 5. The post-prepayment imputation of the initial LTV is therefore as 0.85 (20)=17. If the loan terminates in year 10 (at which point the property is worth $1,125,000), the terminal LTV L(10) is as follows,
L(10)=17e^{0.4}≈25.3.

3. Above Schedule Prepayments

The above exemplary procedures are generally utilized for the prepayment that lies above schedule. However, there may be an additional charge that can be defined by the unpredictability compensation fee on all such above schedule payments. This means that a given dollar of above schedule prepayment may have a smaller proportionate impact on the LTV than would be the case for the equivalent below schedule prepayment.

To converts this scenario into the exemplary model according to the present invention, a prepayment at time t prior to the termination should be considered. As described above, the total debt D(t) at this point can be determined as the LTV at that time L(t), multiplied by the maximum of the valuation at date t, and the initial value of the property. For a prepayment at time t of the dollar amount PP(t), with PP(t)>0.15 D(t), a portion of the prepayment would lie above the schedule. In this case, it is possible to first determine the downward adjustment δ_{S}(t)=0.15 corresponding to the LTV change on the portion of the prepayment that was scheduled. Beyond this situation, a second downward adjustment can be made in the LTV in fractional amount δᵢ(t), where the subscript I indicates that this is an incremental prepayment that lies above the schedule.

To determine this downward adjustment, it is possible to first charge the borrower an unpredictability compensation fee of u on the money, dividing the incremental prepayment [PP(t)−0.15 D(t)] by [1+u] to arrive at the effective incremental prepayment. It is them possible to divide this result by D(t) to arrive at the downward adjustment in the LTV due to the incremental prepayment δ_{I}(t). Further, it is possible to adds the scheduled and incremental downward adjustment to the LTV so as to obtain the overall adjustment factor δ(t)=δ_{I}(t)+δ_{S}(t). To determine the LTV of any loan at payoff when the above-schedule prepayment has been effectuated, it is possible to multiply the actual initial LTV by [1−δ(t)], and thereafter apply the previously described exemplary Dynamic LTV model.

Consider the same example as described above, with the property with initial value V(0)=$500,000, L(0)=20, and R=0.04. For example, the prepayment was made in the amount of PP(5)=$36,600 in year 5 of the loan at which point the value of the property is V(5)=$750,000. With a total debt D(5) determined at this point as $183,000, only 15% of this amount, or $27,450, can be counted on the schedule. Hence the incremental prepayment amount is $9,150. If the unpredictability compensation fee is determined in proportionate terms as u=0.1, this can mean that the effective incremental prepayment is [100/110] $9,150, which is approximately $8,240. Hence the downward adjustment in the LTV due to the incremental prepayment is δ_{I}(t)=8,240/183,00 which is approximately 4.5%. Hence the overall downward adjustment to the LTV due to prepayment δ(5) is about 19.5%. Therefore, at the time of the prepayment in period 5, the total LTV on the loan can be reduced from L(5) as provided by the previously described exemplary model according to the present invention to its post-prepayment level L¹(5), as follows:
L₁(5)=[1−δ(5)]L(5)=0.805 L(5).

Using the same example, the amount that would need to be prepaid in year 5 to payoff the entire outstanding debt is reviewed. The determination of D(t) as being $183,000 gives rise to a maximum scheduled prepayment of $24,450, as indicated above. In order to prepay the remaining 85% of the debt outstanding would preferably utilize a payment of the unpredictability compensation fee on all incremental prepayments. Therefore, an effective incremental prepayment in amount of $158,550 should be then made. Given that u=0.05, the actual prepayment should be [110/100]$158,550=$174,400 in order to arrive at δ(5)=1, thus reducing all subsequent debt to zero.

N. High LTV Dynamic Payoff Model

It is possible to utilize another exemplary embodiment of the present invention in cases where standard mortgages outstanding on the property, by providing the exemplary shared equity loans together or in addition therewith. The LTV on the total loan package inclusive of the shared-equity loans can be relatively high, and thus there may be a risk of default to be considered. The of the object of this exemplary embodiment of the present invention is to enhance the safety the borrower, the other lenders, and the shared-equity lender by reducing the incentive for the borrower to default. As the above-described examples illustrate, the shared-equity loans according to the present invention may have valuable insurance features, since the lender shares certain amount of the risk of falling property prices with the borrower. According to this exemplary embodiment of the present invention, this risk may be reduced so as to benefit all market participants.

An example of such enhancement provided by such exemplary embodiment is provided, e.g., for products with sufficiently high LTV on all loans, shared-equity and conventional. In particular, the basic payout formula can include an additional insurance for the borrower in the case of losses. Such insurance may be attractive to borrowers not only because it brings them direct monetary benefits, but also due to impact in lowering default incentives, and therefore enabling the borrowers to preserve their good record in the credit markets. The high LTV cases use the previously described Dynamic LTV model in accordance to the present invention which defines the LTV at termination. Moreover the payoff formula according to the present invention described above can be used for the property that is valued at least as highly at termination as at point of issuance. However this determination of the amount due may be adjusted down in the case of loss. Specifically, the amount due is what would have been due in the case of no price change, less 50% of any losses (subject to the debt remaining always non-negative). However, the investor value is maintained by the availability of the insurance, incremental or otherwise, on the loan that used the exemplary model of the present invention, would likely not apply to the prepayments that were made during the term of the mortgage.

To illustrate the use of this further exemplary embodiment of the model according to the present invention, consider the loss case that was described above. With the $100,000 loan at constant rental replacement rate R=0.04 is obtained, and the property value falls from $500,000 in year 0 to $400,000 at termination in year 5. Suppose that all of the funds are drawn immediately, that there are no strap-on charges and no prepayments were made. However, further assume that in addition to the $100,000 loan in accordance with the present invention, the borrower took out in year 0 a standard mortgage in amount of $350,000 on the property. In this case, the total initial LTV is 90%. In the standard Dynamic Payoff model, the amount due to the lender would have been 24.4% of $500,000, which is approximately $97,600.

Using the exemplary high LTV formula in accordance with the present invention, the final payoff is defined by starting with 24.4% of the initial property value of $500,000, and then subtracting $50,000 therefrom to account for the equal sharing of losses. Hence the total repayment would be in the order of $72,000. The additional insurance of more than $25,000 not only greatly assists the borrower in a time of need, but also greatly lowers the incentive to default.

1. Minimum Borrowing Amounts with High LTV Model

There may be other variants of the High LTV model to enable a smoothly functioning market with all parties benefiting from the risk reduction. For example, when the total LTV on all loans is above a threshold such as 75%, there may be a minimum initial LTV on the equity-shared portion of the second mortgage. The actual limits can be structured such that the borrower with the total LTV of 80 may have the equity-shared share in at least 20% of losses, so that it will take a 25% fall in property prices to induce negative equity, similarly to a standard equity-based loan in accordance with the present invention with the LTV of 75. In addition, the borrower with the LTV of 85 may have the equity-based share in at least 25% of the losses, so that the default incentives can mimic those of an individual with the equity-shared mortgage of the LTV 80. Another change may be implemented by setting additional up-front costs associated with the use of the equity-shared loans according to the present invention in the high LTV context. It is possible to set the following charges in relation to the total financial package at the initiation of the loan, e.g., adding a fixed high LTV fee as a percentage of the total amount borrowed with all loans that depends on the total assessed LTV at the time of the initiation thereof.

O. Additional Features of Model

Setting rental replacement rate: A function can be implemented to determine the history of market rents, property prices, mortgage rates, and rental replacement rates, which can be used can be used to determine the current rental replacement rate in a given loan and/or housing market. Hence, the rental replacement rate in different times and locations can vary according to market conditions and past history. The current rental replacement rate may vary over time according to market conditions.

Customer Heterogeneity: There will be some customers whose financial history and prospects will make them more attractive than the typical borrower to the lenders which provide loans utilizing the exemplary embodiments of the models in accordance with the present invention, while other borrowers may be less attractive. The exemplary embodiment of the system and process according to the present invention is capable of rejecting certain customers with unsuitable history and prospects, e.g., based on a customer score, and capable of adjusting the pattern of pricing based on this score.

II. Prepayment, Repayment and Other Procedures

Using the exemplary embodiments of the models according to the present invention enable other related issues and concerns to be addressed. For example, the borrowers attempt to obtain low valuations at the time of the prepayment in order to take at least some of the value away from the lenders. Further exemplary embodiments of the present invention are described below to reduce this possible behavior.

A. No Prepayment Close to Sale

There may be situation where the borrowers with significantly higher than pool-average rates of property price appreciation may prefer to prepay as much of the repayment amount as possible immediately prior to the sale of the property, or make such prepayment immediately before undertaking value-enhancing measures. For this reason, a further exemplary embodiment of the model according to the present invention prevents any prepayment of the loan once a notice of sale or termination has been provided, or within a predetermined time period (e.g., 6 months) from the end of the term/termination of the loan.

B. Valuation of Property at Prepayment

The following exemplary procedures according to the present invention can be used to determine the value of the property at the point of prepayment.

Procedure 1; For complete payoffs, the borrower submits an appraisal fee, and this appraisal determines the valuation of the property, subject to an “as is” adjustment. The borrowers of the loans that utilize the exemplary embodiments of the models in accordance with the present invention may be required to maintain their properties in “as is” condition. Reductions in value of the property due to neglects of this requirement are disallowed in the valuation calculation.

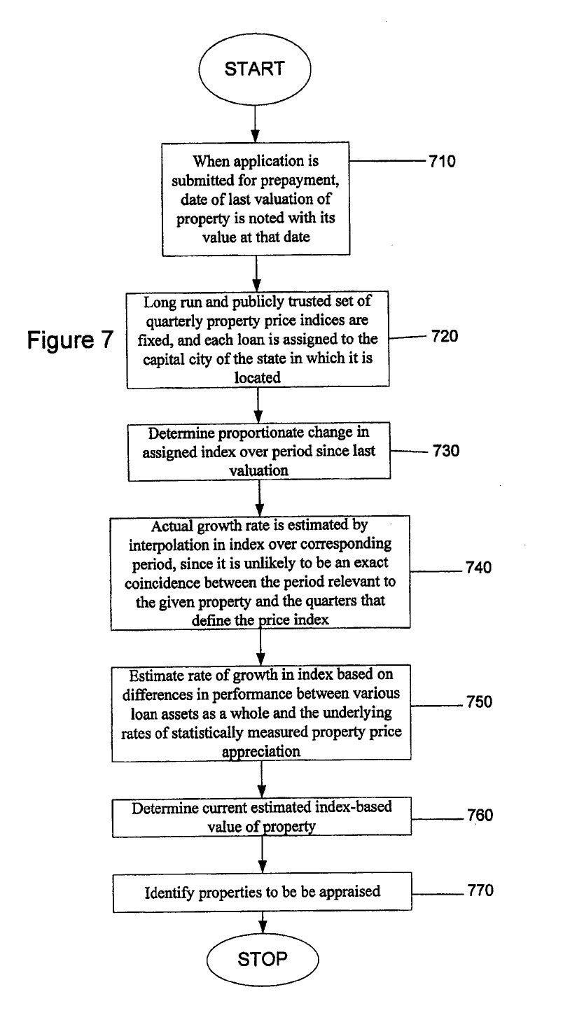

Procedure 2: For scheduled prepayments (i.e. up to 15% of the prepayment amount), the valuation assessed to any given property at a point of the prepayment may be an index-based assessed rate of growth in the value of the asset (e.g., property) since the respective asset was last valued. There are several steps involved in the actual computation, as shown in FIG. 7.

For example, when an application is submitted for a prepayment, the date of the last valuation of the property is noted, together with its value at that date (step 710). The loan process that uses the exemplary embodiment of the model in accordance with the present invention can fix a long run and publicly trusted set of quarterly property price indices, such as ABS indices for capital cities, and each loan is assigned to the capital city of the state in which it is located (step 720). The proportionate change in the assigned index over the period since the last valuation is determined (step 730). An interpolation process can be used to estimate the actual growth rate in the index over the corresponding period, given that there is unlikely to be an exact coincidence between the period relevant to the given property and the quarters that define the price index (step 740).

Further, a numerical adjustment can be made to the rate of growth in the index based on differences in performance between the assets (e.g., loans) that utilize the exemplary model as a whole and the underlying rates of statistically measured property price appreciation in all cities, states and locations taken as a whole (step 750). This adjustment factor can be derived from valuations. It is possible for the exemplary model of the present invention to appraise the properties in the order of 10% of the properties. Each such loan associated with the appraisal will have a predicted rate of the property price increase since initiation based on its city, state and/or location assignment, and this will be subtracted from the actual measured rate of appreciation. Averaging this in a defined manner across the pool can provide various adjustments that may be added to all properties, regardless of location.

The current estimated index-based value of the property will be determined by multiplying the last value of the property by the proportionate change in the relevant property price index over the appropriate period corrected for the adjustment factor (step 760). To discourage prepayments based on the pool appreciation being below that on the owned home, the exemplary embodiment of the present invention can identify additional appraisals for the properties that have paid off, e.g., twice in the last four years (step 770).

C. Initiation Procedures

According to another exemplary embodiment of the present invention, if there is a market transaction, then the initial valuation may be the lower of the purchase price less all fees and expenses, and the appraised value. If there is no market transaction, the initial value is set at 95% of the appraised value to guard against an adverse selection, whereby those who are over-valued have a greater incentive to use the finance. As a further safeguard against the adverse selection when there has been no market transaction, the borrowers can be requested to attest in writing that they have not commissioned other appraisals in the last 2 years, except in the situation in which full reports of the appraisals have bee provided to the lenders.

In addition, the borrowers may be requested to attest that they have not applied for other value dependent mortgages, and if they have, they must provide the terms on which the borrowers were offered such loan products. Once the borrower applies for one or more loans that utilize the exemplary embodiments of the model in accordance with the present invention, the borrower may have a specified time window in which to complete an application for such specific loan product, and pay the associated application fees. At that time, the lender may be required to provide the funds on the agreed terms within a further specified time window. However, the application for funds is not filed by the borrower or received by the lender in the specified time window, the offer can be voided, and any new application may require a new valuation. It is possible to set a minimum time between successive applications of 2 years to prevent the property hold “trawling” for the appraisals.

D. Terminal Valuation

A contract for the loan can specify a notification period of any length prior to the sale of the property, and it should provide that an appraiser must be granted entry. If no notice is received by the lender, an appraisal can be effectuated in the time window of 6-12 weeks prior to the termination. The actual termination date can proceed after such final valuation. After such valuation, the borrower may be provided with a statement of the amount due to the lender at the termination, and can obtain additional information to determine additional costs should the repayment be delayed. If the valuation is precluded for any reason that is the fault of the borrower, then the valuation can be set at 110% of estimated valuation obtained by the lender or a third party. If there is then a sale of the property, the seller or seller's representative should notify the lenders. At that point, the final value of the property can be obtained, which can be established as the maximum of the appraised value and the price after subtraction of all fees. The, the borrower would be notified of the final payoff amount.

Instead of the full appraisal, it is possible to compare the gross sale price of the property before all fees and expenses with a desk valuation, and request a report (e.g. an auction report) to indicate that the sale was at arms length. If the report is irregular, or if the property sells for an amount, e.g., 5% below market value of similar properties, an actual valuation can be performed by the lender, e.g., within 2 days of the receipt of the report.

If the property is put on the market but does not sell within a pre-specified window, payoff would not have to be made. However, at this point, a fee may be charged for all costs incurred in the sale process. The contract will incorporate a clause that specifies that should the property be sold within a certain window, the lender may have the right to treat the payoff value as the maximum of the appraised value at the earlier point and the gross sale price of the property before all fees and expenses.

E. Termination Through Loss of Owner Occupation

In accordance with another exemplary embodiment of the present invention, the loans associated with the equity-shared model in accordance with the present invention may prefer the borrower to maintain the occupation of the property (e.g., occupancy for at least 180 days a year). Upon leaving this status (e.g. switching to a secondary home status), the borrower may be requested to inform the lender, whereupon the standard valuation-based termination process may be initiated.

III. Enhancing Predictability

It may be preferable to provide the investors in pooled debt interests with reassurance that the borrowers will likely behave in a predictable manner, and will not hold on to the mortgages for an unduly long time. Thus, it may be beneficial for the borrowers on various loans to be induced to provide information regarding, e.g., predictable timing of payoff of the loans, and preventing unpredictable payoffs of the loans to reduce the profits that may be due to the investors. The likelihood or predictability of payoffs will be enhanced by the contractual terms of the mortgage, which give effect to some or all of the features described in the examples (e.g., calculation of terminal value), and by the manner of disclosure of those terms to the borrower (e.g., scenarios of terminal value at the maturity date). The predictability will be further advanced by the education of borrowers through the systems for mortgage origination and the disclosures made prior to the loan.

Further exemplary embodiments of the models of the present invention are capable of adding to the predictability of holding periods of the loans that utilize such models, which can be applied to the shared-equity loan markets and loans, as well as to other loan products and installment debt products. For example, the investors can derive additional stability by knowing when they will receive the returns on their investment, and that the amounts are maximized. Indeed, providing the investors with the predictability of the payoff dates, pricing models in accordance with the present invention can be designed to ensure that borrowers who are likely to pay off in a particular period have an incentive to borrow using a particular loan that is priced to offer the lowest price in return for providing this precise time window of repayment.

A. Uncertain Payoff Times on Securitized Debt Instruments

In asset markets, debts of all forms are generally securitized, and interests in the debt payments can be sold to the investors. Some of such markets are mortgage backed securities that are sold on the secondary mortgage markets. These are the markets in which standard interest paying mortgages are generally sold onto a broader class of the investors, with various enhancements such as pool insurance to provide reassurances to certain nervous investors. In valuating these financial instruments, one of the risks may concern the timing of payouts, which can have a significant influence on the value of such instruments. In the case of the mortgage backed securities, these risks may arise both due to the uncertainty concerning the timing of refinancing induced prepayments, and the uncertainty concerning turnover times on the underlying properties.

In a thickly traded market such as that in conforming mortgage securities, refinancing induced prepayment risk may be one of the dominant concerns due to its direct impact on the values of the assets. However, even for the debts in which this form of risk is not very significant, the timing of payoffs to the investors may be highly uncertain. For example, when conforming thirty year mortgages issued at historically low interest rates are sold into the market, the risk may arise not necessarily from the prepayments induced by refinancing (which are likely to be minimal), but rather from the reductions in the debt due to an influx of money, or sale of the home. Currently, such uncertainty is not really addressed. Indeed, there has been likely no discussion as to the introduction of incentives that might give rise to a more predictable pattern of payoffs.

B. Why Uncertain Payoff Times Reduce Asset Values

Many investors in asset-backed securities may be interested in assurances not only on the amount of money that their investment will ultimately produce, but also on when this money will be realized. In the case of the SAMs issued by the Bank of Scotland, it is the unpredictable timing of payouts that may result in the need to produce a hybrid instrument in which a predictable flow of interest from the standard mortgage was overlaid on top of the payoffs on the SAMs. The benefits of having the predictability is particularly acute in relatively non-liquid asset markets, in which the need to quickly raise funds in certain times may result in the investor taking a significant loss.

C. Enhancement Predictability of Payoff Times

There may be at least three areas addressed by exemplary embodiments of the models of the present invention to enhance the payoff predictability of debt instruments, e.g., (i) product pricing, (ii) customer matching, and (iii) setting of asset manager incentives, which can be applied to shared equity mortgages/loans as well as to conventional mortgages/loans.

1. Self Selection and Preferred Habitat

For example, the borrowers can provide a relatively inexpensive access to funds if they terminate within a relatively short horizon (their “preferred habitat”), yet offering these borrowers the option to extend beyond this period should they have a need for the funds that lasts longer than they initially expect.

2. Nominating a Preferred Termination Window

Given the importance of predictability to the investors, another pricing model with respect to borrowing instruments offers the customers the right to select, e.g., a 12 month period during which they may be offered a discount on the borrowing costs. For example, the borrowers who are confident of the specific short period (e.g., several months, one year, etc. in duration) in which they anticipate terminating the loan, will have the right to specify exactly this time period at the contract/loan initiation. The borrowers would then receive a discount should they terminate the loan within their specified window. Otherwise, they would be subjected to a surcharge if they miss the time window.

3. Unpredictability Compensation Fees

The lenders may wish to understand and influence the termination behavior not only at the point of application for the loan, but also during the later life of the loan. Various unpredictability fees may be important to this goal not only in the equity-sharing loan product setting, but also for other loans in which the predictability of tenure is important.

D. Self Selection and Preferred Habitat

In the context of shared-equity loans which utilize the exemplary model in accordance with the present invention (e.g., the Dynamic LTV model), the preferred habitat H that may be shorter than the maximum term M. The borrower who takes out a loan product with the preferred habitat H shorter than maximum term M may be provided the automatic option to roll it over until the end of term. However, the exercise of this option can be costly for the investors, since it makes the time path of payoffs significantly harder to predict, and may impose various costs on the investors as a result of the mismatch between anticipated and actual timing of the payoffs. Therefore, any borrower who wishes to exercise the option may have to pay a standard “unpredictability compensation fee” on the amount rolled over, as described herein. By providing that the rates are set relative to one another in an appropriate fashion, one can ensure that those who believe that they will terminate within a given period select the loan instrument that is highly revealing of this tenure expectation to the market as a whole. Further, by allowing for a longer maximum habitat, the borrower who is uncertain about the tenure is able to produce some insurance against surprises.

1. Exemplary Embodiment

In the case shared-equity loans which utilize the exemplary embodiment of the models of the present invention, the term structure of the usage of funds/rental replacement rates and the unpredictability compensation fees encourage self selection by the borrowers. The term structure of interest rates on money is provided in a similar manner as that for the rental replacement rates, which are analogous to interest rates on housing services. The term structure is generally upward sloping to encourage those who wish to terminate in the relatively near future to select products of relatively short term. It is also set in such a manner that the (H,M)=(10,10) product is cheaper for an individual with a high chance of wishing to extend beyond the five year term, while the (H,M)=(5,10) loan product is expected to be cheaper for the individual who is more likely to terminate within 5 years. The example below illustrates how the combination of rental replacement rates and the unpredictability compensation fees may be used to encourage self selection at point of application according to expected holding periods and in addition the level of uncertainty concerning these holding periods.

2. Examples

Consider the standard example above of a $500,000 property with a $100,000 equity-shared loan which utilizes the exemplary model of the present invention initiated at time 0. Further consider a setting in which four different individuals are applying for the loan. Individual A is sure to terminate in year 4, individual B is sure to terminate in year 6, individual C believes that termination in year 4 has probability 0.9 while termination in year 6 has probability 0.1, while individual D believes that the reverse is true, with probability 0.9 of terminating in year 6, and only a 0.1 probability of terminating in year 4. Assume that R(5,5)=0.03, R(5,10)=0.04, that R(10,10)=0.05 and that u=0.1.

In this case, individual A will reveal short tenure expectations by selecting the product with (H,M)=(5,5) in which the cost of capital out to year 4 is lowest, while individual B will reveal long tenure expectations by picking the product with (H,M)=(10,10) which is cheaper out to year 6 than the only other product with sufficient duration, for which the unpredictability compensation fee is excessive. Individual C has an incentive to pick the product with (H,M)=(5,10), because there is a 0.9 probability that this will cost significantly less in the LTV terms than with (H,M)=(10,10), and only a 0.1 probability of the opposite. Finally, individual D has an incentive to pick (H,M)=(10,10), because there is a 0.9 probability that this will cost significantly less in LTV terms than the option (H,M)=(5,10), and only a 0.1 probability of the opposite end.

E. Nominating a Preferred Termination Window

According to another exemplary embodiment of the present invention, the customers may have the right to select particular time period (e.g., a 12 month period) during which they may be offered a discount on the borrowing costs of the loan. The pricing innovation is that they receive a discount should they hit their specified window. The cost is that they face a surcharge if they miss the window. Thus, one of the benefits of this exemplary embodiment is that it appeals to those borrowers who are confident about the termination date of the loan that they are selecting. In addition, with a sufficiently high discount on offer, some may take out the loan product, and terminate in the window just because of the monetary benefits to them. This will be of mutual benefit to the lenders and borrowers given the advantages of the payoff predictability.

F. Predictability Compensation Fees

The lenders may wish to understand and influence the termination behavior of the borrowers, not only at the point of the application for the loan, but also during the later life of the loan. Various unpredictability fees may be used to achieve this goal not only in the equity-sharing mortgage market, but also for other loans for which predictability of tenure may be important. These apply to the above-scheduled loan prepayments, and may limit the incentives for the borrower to prepay during the life of the loan.

In the shared-equity loan/mortgage context, the investors may wish to hold to the real estate returns for a predictable period of time, so that the early termination is costly therefor. At least for this reason, a schedule of maximum annual prepayment may be provided such that little or no unpredictability compensation payment would be needed. The schedule may prevent the prepayments in the first two years of the mortgage, thereafter specifying that a 15% share of the outstanding mortgage can be prepaid in each year. In any year in which the prepayments are permitted (e.g., after year 2), the borrower will be able to pay off some portion or the whole loan amount. However, doing so may trigger an unpredictability compensation fee, e.g., on the 85% of the loan that is above the schedule.

G. Customer Matching

In this exemplary embodiment of the present invention, the borrowers are encouraged to understand which product to select based on their tenure expectations. With this in mind, yet another exemplary embodiment of the present invention, it is possible to provide various information systems, processing arrangement, software products and models to assist the customers to decide on the option that is best suited for them. By using such a customer interface which would provide such computerized assistance, not only will borrowers be able to identify the best product in light of their expectations, but they will also be encouraged to provide additional information that will of value in predicting the expected holding period for the loan in question.

In the shared equity mortgage context which utilize the exemplary models of the present invention, the borrower may be guided to the best product in light of their tenure probabilities and the costs they assess to having to terminate prior to the end of the period during which they would ultimately have liked to hold the loan. This exemplary model may include and consider not only expectations concerning the tenure of the loan, but also a penalty function indicating the cost to the borrower of being forced to terminate the loan earlier than desired, and a method of incorporating beliefs about the costs of rolling over short term instruments to arrive at a longer term solution.

H. Predictability Incentives for Asset Managers

To obtain predictable timing, various incentives may be provided for asset managers to match the tenure of their asset holders closely with the prediction made at the initiation of the loan process (or at the loan acceptance) that can match the preferences of the investors. The exemplary procedure for matching the investor habitat preferences with those of the borrowers, which can be used the shared equity mortgage market and other conventional markets, such as the market for standard mortgage backed securities.

I. Further Exemplary Embodiments

It should be understood that the description herein regarding loans and mortgages for real property which use the exemplary embodiments of the model in accordance with the present invention also include any form of investment in the relevant property. Accordingly, where the term “debt” is used, it will also include any relationship between the homeowner and the provider of the investment, however characterized at law or recorded or evidenced, under which a person (the provider of the investment capital) acquires an interest in the real property separate from, or in addition to, the homeowner by way of investment. The term “investment” can mean but is not limited to any investment in, or exposure to, real property, whether made by way of or in the form of a loan or other financial accommodation, or to acquire any equitable or legal interest in real property, whether that investment is made in the form of a loan, whether secured by mortgage or not, a joint venture interest, an account of profits, a partnership interest or as a tenancy in common in the property.

In addition, the term “advance” as used herein can mean, but is not limited to any payment made to a homeowner by the lender which utilizes the exemplary embodiments of the model in accordance with the present invention, whether in the nature of a loan or other financial accommodation or as an investment in the property.

In addition, the term “mortgage” as used herein can mean, but is not limited to any agreement in writing under which the relationship of the homeowner and the lender described herein above can be defined in respect of the investment.

Further, the term “homeowner” as used herein can mean, but is not limited to the person, persons or other entity/entities to whom the advance is made, whether the relationship to that person is one of debtor/creditor or co-owner, partner or joint venturer.

In accordance with other exemplary embodiments of the present invention, the exemplary models described herein can be used to create a true equitable interest in residential real property, in a form of “investment” suitable for aggregation through security pools, appropriate for investment products (e.g., may be different from pools of residential mortgage-backed securities). In addition, the manner in which the investments would relate to conventional mortgages is addressed by a further exemplary embodiment of the present invention in that these investments/loans which utilize the exemplary model according to the present invention can be marketed, offered, administered and terminated in conjunction with a conventional mortgage. Indeed, using such further exemplary model in accordance with the present invention provides an ability to the homeowner to switch back and forth between the debt and equity components of the mortgage. In addition, the pre-payment and multi-draw facility exemplary features of the loan/investment according to the present invention an be used in such model, along with the possibility to use an insurance policy for both mortgage components. Thus, the risk profile of the loan/investment lender may be reduced, while applying this reduction to the benefit of the homeowner

Furthermore, according to yet another exemplary embodiment of the present invention, a compilation of specific classes of investments, designated by region, demographics, property value, etc. can be utilized. This can permit strategies of active management. The pools can be used for a variety of investment products, both retail and wholesale. Through the construction of pools, this exemplary embodiment of the present invention can allow for a variety of manifestations of the investment return, and providing the ability to manage inter-generational wealth transfer through an investment platform in accordance with the present invention.

The exemplary embodiments of the models according to the present invention described herein are not applicable to only loans or debt instruments. For example, these exemplary models can be used by direct purchasing the equity in the property, and then using the exemplary models, further transferring the equity interests thereto over time. In this manner, it is possible for a party making the investment to increase an equity position to the property over time.

The foregoing merely illustrates the principles of the invention. Various modifications and alterations to the described embodiments will be apparent to those skilled in the art in view of the teachings herein. It will thus be appreciated that those skilled in the art will be able to devise numerous systems, processes, models and arrangements which, although not explicitly shown or described herein, embody the principles of the invention and are thus within the spirit and scope of the invention. It should be understood that the exemplary embodiments of the models according to the present invention can be implemented using one or more processing arrangements (e.g., personal computers, minicomputers, mainframes, personal digital assistants, laptops, notebooks, etc.), in software (via coded computer programs, programmed/hardwired computer instructions, in source format, object format, machine-code format, etc.) that can be used to configure the processing arrangement to execute the exemplary model(s), stored on storage computer-readable medium (e.g., hard drives, RAMs, ROMs, CD-ROMs, floppy disks, RAIDs, memory sticks, etc.), or another other device which can store and/or execute the exemplary models described herein. All publications and references referred to above are incorporated herein by reference in their entireties.

1-24. (canceled)

25. A process for providing a model to determine a repayment value on a financial vehicle which is at least one of a loan or an investment for an asset, using a processing arrangement, comprising:
a) providing a first variable associated with at least one of an actual time or an estimated time when the financial vehicle remains unpaid;
b) providing a second variable associated with at least one of a sale price of the asset or a valuation of the asset at a later point in time; and
c) providing the model which is based on, at least in part, the first variable and the second variable.

26. The process according to claim 25, further comprising:
d) obtaining data associated with substantially unmodifiable conditions of the financial vehicle provided by a borrower of the financial vehicle; and
e) establishing the model based on, at least in part, the data.

27. The process according to claim 26, wherein the financial vehicle is the loan, and wherein the model includes the time period when the loan is to be satisfied.

28. The process according to claim 27, wherein the conditions include a time period for satisfying the loan, and further comprising increasing the repayment value if the loan in not satisfied within the time period.

29. A process for establishing a model for a financial vehicle which is at least one of a loan and an investment for an asset, using a processing arrangement, comprising:
a) obtaining first data associated with substantially unmodifiable conditions of the loan provided by a borrower of the financial vehicle;
b) obtaining second data associated with at least one of a sale price of the asset or a valuation of the asset at a later point in time; and
c) establishing the model based on, at least in part, the first data and the second data.

30. The process according to claim 29, wherein the financial vehicle is the loan, and wherein the model includes the time period when the loan is to be satisfied.

31. The process according to claim 30, wherein the conditions include a time period for satisfying the loan, and further comprising increasing the repayment value if the loan in not satisfied within the time period.

32. The process according to claim 29, further comprising:
d) obtaining third data associated with at least one of an actual time or an estimated time when the financial vehicle remains unpaid; and
e) modifying the model as a function of, at least in part, the third data.

33. (canceled)

34. A storage medium which provides thereon a software arrangement, wherein, when executed on a processing arrangement, the software arrangement is capable of configuring the processing arrangement to establish a model to determine a repayment value on a financial vehicle which is at least one of a loan and an investment for an asset, using the steps comprising:
a) providing a first variable associated with at least one of an actual time or an estimated time when the loan remains unpaid;
b) providing a second variable associated with at least one of a sale price of the asset or a valuation of the asset at a later point in time; and
c) providing the model which is based on, at least in part, the first variable and the second variable.

35. A storage medium which provides thereon a software arrangement, wherein, when executed on a processing arrangement, the software arrangement is capable of configuring the processing arrangement to establish a model for a financial vehicle which is at least one of a loan and an investment for an asset, comprising:
a) obtaining first data associated with substantially unmodifiable conditions of the loan provided by a borrower of the financial vehicle;
b) obtaining second data associated with at least one of a sale price of the asset or a valuation of the asset at a later point in time; and
c) establishing the model based on, at least in part, the first data and the second data.

36. (canceled)

37. A software arrangement which, when executed on a processing arrangement, is capable of configuring the processing arrangement to provide a model to determine a repayment value on a financial vehicle which is at least one of a loan and an investment for an asset, using the steps comprising:
a) a first set of instructions which is capable of configuring the processing arrangement to provide a first variable associated with at least one of an actual time or an estimated time when the loan remains unpaid;
b) a second set of instructions which is capable of configuring the processing arrangement to provide a second variable associated with at least one of a sale price of the asset or a valuation of the asset at a later point in time; and
c) a third set of instructions which is capable of configuring the processing arrangement to provide the model which is based on, at least in part, the first variable and the second variable.

38. A software arrangement which, when executed on a processing arrangement, is capable of configuring the processing arrangement to establish a model for a financial vehicle which is at least one of a loan and an investment for an asset, comprising:
a) a first set of instructions which is capable of configuring the processing arrangement to obtain first data associated with substantially unmodifiable conditions of the loan provided by a borrower of the financial vehicle;
b) a second set of instructions which is capable of configuring the processing arrangement to obtain second data associated with at least one of a sale price of the asset or a valuation of the asset at a later point in time; and
c) a third set of instructions which is capable of configuring the processing arrangement to establish the model based on, at least in part, the first data and the second data.

39. (canceled)
